(19) United States
(12) Patent Application Publication
(10) Pub. No.: US 2004/0135616 A1
(43) Pub. Date: Jul. 15, 2004

(54) Control signal generation circuit and method for generating control signal controlled in units of bit time

(75) Inventors: Jang-Seok Choi, Seoul (KR); Sang-Gyu Lim, Suwon-city (KR)

Correspondence Address: Steven M. Mills, MILLS & ONELLO LLP, Eleven Beacon Street, Suite 605, Boston, MA, 02108, US

(73) Assignee: Samsung Electronics Co., Ltd.

(21) Appl. No.: 10/743,355

(22) Filed: Dec. 22, 2003

(30) Foreign Application Priority Data
Jan. 15, 2003 (KR) 03-2756

(51) Int. Cl. G06F 1/04

(52) U.S. Cl. 327/291

(57) ABSTRACT

Provided are a control signal generation circuit and a method for generating a control signal controlled in units of bit time of a clock signal. The control signal generation circuit includes an input terminal, a first output terminal, and a second output terminal. The control signal generation circuit receives an input signal inputted to the input terminal in response to a clock signal and outputs a column latch signal and a data input/output command signal, which are separately activated and have a first time interval therebetween, to the first input terminal and the second input terminal, respectively, each in response to a test enable signal at a first state, or outputs the column latch signal and the data input/output command signal, which are separately activated and have a second time interval therebetween, to the first output terminal and the second output terminal, respectively, each in response to a test enable signal at a second state. The first time interval and the second time interval are controlled in units of bit time of the clock signal, and the second time interval is controlled to be smaller than the first time interval. The first time interval and the second time interval each amount to a time from when the column latch signal is activated to when the data input/output command signal is activated.

### CROSS REFERENCE TO RELATED APPLICATION

This application claims priority under 35 U.S.C. §119 from Korean Patent Application No. 2003-2756, filed Jan. 15, 2003, the contents of which are hereby incorporated by reference in their entirety as if fully set forth therein.

### BACKGROUND OF THE INVENTION

1. Field of the invention

The present invention relates to a semiconductor integrated circuit, and more particularly, to a control signal generation circuit and a method for generating a control signal, which make it possible to control a column latch signal to data input/output command signal setup time (hereinafter, referred to as a setup time) in units of bit time of a clock signal.

2. Description of the Related Art

Semiconductor memory devices select a memory cell among a plurality of memory cells configured in a memory cell array through memory addressing, and read data from the selected memory cell through a data read operation or write data to the selected memory cell through a data write operation.

FIG. 1 is a block diagram illustrating column selection and memory access according to prior art. FIG. 2 is a timing diagram illustrating column selection and memory access according to prior art.

Hereinafter, the data read operation will be described with reference to FIGS. 1 and 2. Since row selection and memory access are well known to those skilled in the art, they will not be described here.

An interface 10 receives a data write/read command signal CMD and an address Ai, which are synchronized with a clock signal CLK, through pins (not shown) and generates control signals including a column latch signal COLLAT, a data input/output command signal COLCYC, and an address Ai', all of which are used to control memory access.

The interface 10 receives input data DIN and outputs a write data signal WD to an input/output sense amplifier 80, or receives a read data signal RD outputted from the input/output sense amplifier 80 and outputs the read data signal RD as an output data signal Dout.

The column latch signal COLLAT, as a control signal used to latch a column address, indicates that the address Ai' outputted from the interface 10 corresponds to the column address to be latched.

The data input/output command signal COLCYC, as a control signal used to control data read and write operations on a selected column, is activated after the column latch signal COLLAT is activated as shown in FIG. 2.

Functions of and the relationship between the column latch signal COLLAT and the data input/output command signal COLCYC are well known to those skilled in the art, and thus they will not be described here.

A column address latch 30 outputs a column address CAi based on the address Ai' that is received in response to the column latch signal COLLAT. A column decoder 20 receives the column latch signal COLLAT and the column address CAi and generates a column select line output signal CSL used to drive a column select line corresponding to the column address CAi.

A column selector 50 transmits data of a pair of bit lines BL and BLB to a pair of local input/output lines IO and IOB in response to the activated column select line output signal CSL. The data of a pair of bit lines BL and BLB are outputted from a memory cell array 70 and sensed and amplified by a bit line sense amplifier 60.

An input/output sense amplifier controller 40 generates an input/output sense amplifier enable signal PIOSE in response to the activated data input/output command signal COLCYC.

An input/output sense amplifier 80 senses and amplifies data of a pair of local input/output lines IO and IOB and transmits the data of the pair of local input/output lines IO and IOB to a pair of global input/output lines GIO and GIOB as the read data signal RD in response to the activated sense amplifier enable signal PIOSE.

That is, the column select line output signal CSL is activated in response to the activation of the column latch signal COLLAT. The data, outputted from the memory cell array 70, sensed and amplified by the bit line sense amplifier 60 are transmitted to the pair of local input/output lines IO and IOB by the column selector 50 in response to the activated column select line output signal CSL. The input/output sense amplifier 80 develops the data of the pair of local input/output lines IO and IOB. The developed data is transmitted as the read data signal RD to the pair of the global input/output lines GIO and GIOB in response to the data input/output command signal COLCYC that is activated after the column latch signal COLLAT is activated.

Referring to FIG. 2, a setup time tCLS denotes a time interval from when the column latch signal COLLAT is activated to when the data input/output command signal COLCYC is activated. Here, the setup time tCLS is equal to 2tCK, where 1tCK denotes one period of the clock signal CLK. A bit time is half of 1tCK, and thus 1tCK is equal to 2-bit time.

In prior art, a semiconductor memory device cannot control the setup time tCLS. Thus, if the operating frequency of the semiconductor device is higher than that of test equipment used to test the semiconductor memory device, it is not possible to effectively test the semiconductor memory device using the test equipment. Therefore, it is difficult to obtain known good die (KGD) in semiconductor device testing.

### SUMMARY OF THE INVENTION

The present invention provides a control signal generation circuit and a method for generating a control signal, which make it possible to control a column latch signal to data input/output command signal setup time in units of bit time, thereby allowing a semiconductor memory device to be effectively tested.

According to an aspect of the present invention, there is provided a control signal generation circuit comprising an input terminal, a first output terminal, and a second output terminal. The control signal generation circuit receives, in response to a clock signal, an input signal inputted to the input terminal and outputs a column latch signal and a data input/output command signal, which are separately activated and have a first time interval therebetween, to the first output terminal and the second output terminal, respectively, each in response to a test enable signal at a first state, or outputs the column latch signal and the data input/output command signal, which are separately activated and have a second time interval therebetween, to the first output terminal and the second output terminal, respectively, each in response to a test enable signal at a second state. The first time interval and the second time interval are controlled in units of bit time of the clock signal, and the second time interval is controlled to be smaller than the first time interval.

In one embodiment, the first time interval and the second time interval each amount to a time from when the column latch signal is activated to when the data input/output command signal is activated.

According to another aspect of the present invention, there is provided a control signal generation circuit comprising a first latch which latches an input signal in response to a clock signal, a second latch which latches an output signal of the first latch in response to the clock signal, a selection circuit which outputs the output signal of the first latch or an output signal of the second latch as a column latch signal in response to a test enable signal, and a third latch which latches the output signal of the second latch as a data input/output command signal in response to the clock signal. The amount of time from when the column latch signal is activated to when the data input/output command signal is activated is controlled in units of bit time of the clock signal.

In one embodiment, the input signal is generated by decoding a data write/read command signal and is activated in response to the data write/read command signal.

The control signal generation circuit can further comprise a first inverter which is connected between an output terminal of the first latch and a first input terminal of the selection circuit, a second inverter which is connected between the output terminal of the first latch and an input terminal of the second latch, and a third inverter which is connected between the output terminal of the second latch and an input terminal of the third latch. The output terminal of the second latch is connected to a second input terminal of the selection circuit.

The output signal of the first latch can be an inverted signal of the input signal.

According to yet another aspect of the present invention, there is provided a control signal generation circuit comprising a first latch which latches an input signal in response to a clock signal, a second latch which latches an output signal of the first latch in response to the clock signal, a third latch which latches an output signal of the second latch in response to the clock signal, and a selection circuit which outputs one of the output signal of the second latch and an output signal of the third latch in response to a test enable signal. The amount of time from when the output signal of the first latch is activated to when an output signal of the selection circuit is activated is controlled in units of bit time of the clock signal.

The control signal generation circuit can comprise a first inverter which inverts the output signal of the first latch, a second inverter which is connected between an output terminal of the first latch and an input terminal of the second latch, and a third inverter which is connected between an output terminal of the second latch and an input terminal of the third latch. The selection circuit has a first input terminal connected to an output terminal of the third latch and a second input terminal connected to the output terminal of the second latch.

The output signal of the first latch can be a column latch signal, and the output signal of the selection circuit can be a data input/output command signal.

The output signal of the first latch can be an inverted signal of the input signal.

According to yet another aspect of the present invention, there is provided a method for generating a control signal. The method comprises receiving a data write/read command signal inputted to an input terminal of a control signal generation circuit, in response to a clock signal and outputting a column latch signal and a data input/output command signal, which are separately activated and have a first time interval therebetween, to the first input terminal and the second input terminal, respectively, each in response to a test enable signal at a first state, or outputting the column latch signal and the data input/output command signal, which are separately activated and have a second time interval therebetween, to the first output terminal and the second output terminal, respectively, each in response to a test enable signal of a second state. The first time interval and the second time interval are controlled in units of bit time of the clock signal, and the second time interval is controlled to be smaller than the first time interval.

The first time interval and the second time interval can each amount to a time from when the column latch signal is activated to when the data input/output command signal is activated.

### BRIEF DESCRIPTION OF THE DRAWINGS

The foregoing and other objects, features and advantages of the invention will be apparent from the more particular description of a preferred embodiment of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram illustrating column selection and memory access according to prior art.

FIG. 2 is a timing diagram illustrating column selection and memory access according to prior art.

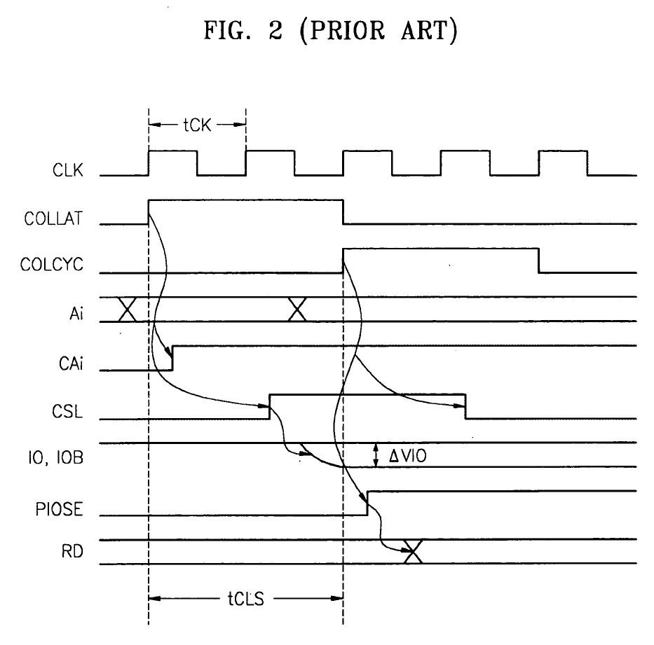

FIG. 3 is a circuit diagram of a control signal generation circuit according to a first embodiment of the present invention.

FIG. 4 is a timing diagram for the control signal generation circuit according to the first embodiment of the present invention.

FIG. 5 is a circuit diagram of a control signal generation circuit according to a second embodiment of the present invention.

FIG. 6 is a timing diagram for the control signal generation circuit according to the second embodiment of the present invention.

### DETAILED DESCRIPTION OF THE INVENTION

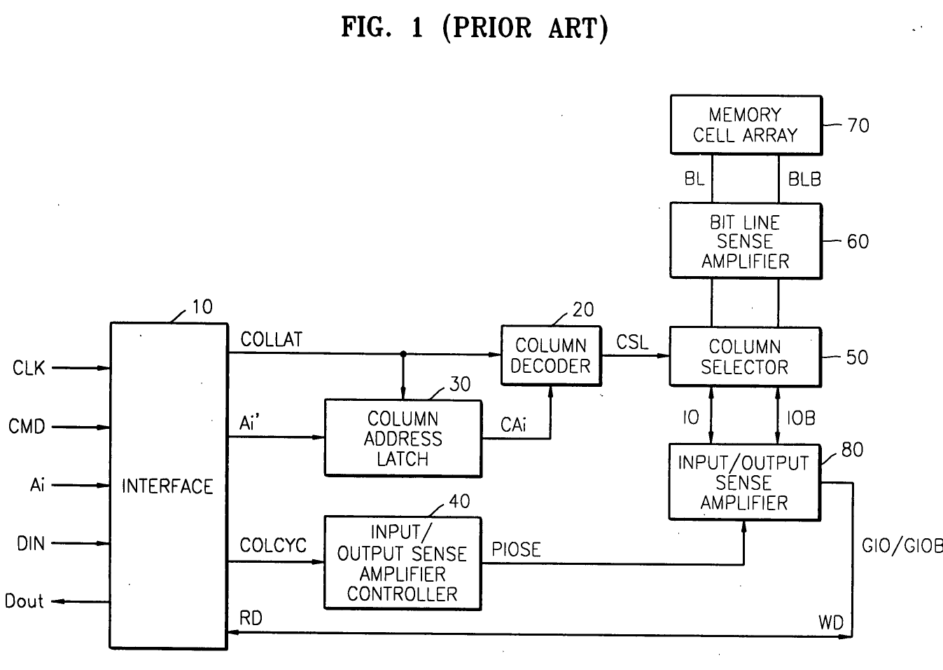

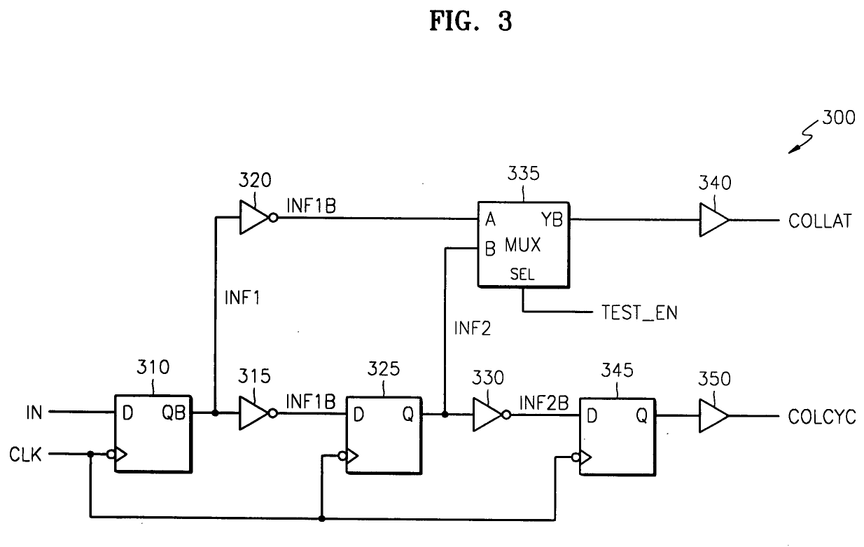

FIG. 3 is a circuit diagram of a control signal generation circuit 300 according to a first embodiment of the present invention. Referring to FIG. 3, the control signal generation circuit 300 generates a column latch signal COLLAT and a data input/output command signal COLCYC in a semiconductor memory device which can write data to and read data from a memory cell array. The control signal generation circuit 300 corresponds to the interface 10 of FIG. 1.

The control signal generation circuit 300 includes a first latch 310, a second latch 325, a third latch 345, and a selection circuit 335.

The first latch 310 latches an input signal IN in response to a clock signal CLK. The second latch 325 latches an output signal of the first latch 310 in response to the clock signal CLK. The selection circuit 335 outputs the output signal INF1 of the first latch 310 or an output signal INF2 of the second latch 325 as the column latch signal COLLAT corresponding to the state (logic high or low) of a test enable signal TEST_EN. The third latch 345 latches the output signal INF2 of the second latch 325 as the data input/output command signal COLCYC in response to the clock signal CLK. A setup time (tCLS) from when the column latch signal COLLAT is activated to when the data input/output command signal COLCYC is activated is controlled in units of bit time of the clock signal CLK.

The control signal generation circuit 300 of FIG. 3 controls when the column latch signal COLLAT is activated.

The control signal generation circuit 300 further includes a first inverter 320, a second inverter 315, a third inverter 330, and two buffers 340 and 350 considering a relationship among the phases of the input signal IN, the column latch signal COLLAT, and the data input/output command signal COLCYC.

Hereafter, the control signal generation circuit 300 is described to facilitate understanding of its operation of controlling the setup time tCLS in units of bit time.

The first latch 310 transmits the input signal IN inputted to its input terminal D to the first inverter 320 and the second inverter 315 through its output terminal QB in response to a falling edge of the clock signal CLK.

The input signal IN is generated by decoding the data write or read command CMD. If the input signal IN is active high, it is not necessary to include the first, second, and third inverters 320, 315, and 330 in the control signal generation circuit 300.

The first inverter 320 is connected between the output terminal QB of the first latch 310 and a first input terminal A of the selection circuit 335, inverts the output signal INF1 of the first latch 310 into an inverted output signal INF1B, and outputs the inverted output signal INF1B to the first input terminal A of the selection circuit 335.

The second inverter 315 is connected between the output terminal QB of the first latch 310 and an input terminal D of the second latch 325, inverts the output signal INF1 of the first latch 310 into an inverted output signal INF1B, and outputs the inverted output signal INF1B to the input terminal D of the second latch 325.

The second latch 325 outputs the output signal INF1B of the second inverter 315 as the output signal INF2 to the third inverter 330 and a second input terminal B of the selection circuit 335 in response to the falling edge of the clock signal CLK. The third inverter 330 is connected between an output terminal Q of the second latch 325 and an input terminal D of the third latch 345.

The third latch 345 transmits the inverted output signal INF2B of the third inverter 330 to the buffer 350 in response to the falling edge of the clock signal CLK. The buffer 350 buffers the inverted output signal INF2B transmitted from the third latch 345 and outputs the buffered result as the data input/output command signal COLCYC.

The selection circuit 335 outputs the inverted output signal INF1B of the first inverter 320 or the output signal INF2 of the second latch 325 to the buffer 340 in response to the test enable signal TEST_EN. The buffer 340 buffers an output signal of the selection circuit 335 and outputs the buffered result as the column latch signal COLLAT. The selection circuit 335 may be a two-input/one-output multiplexer.

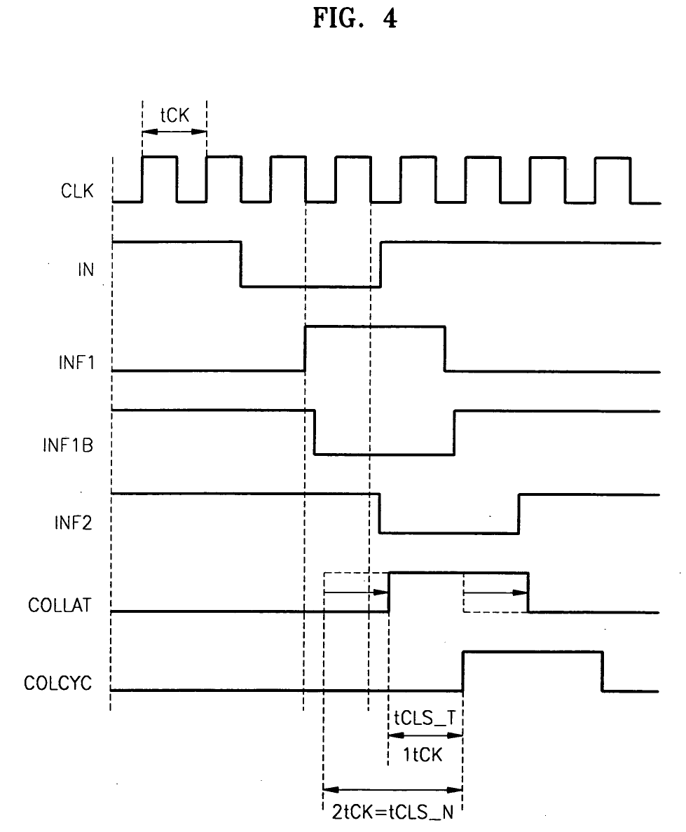

FIG. 4 is a timing diagram for the control signal generation circuit 300 according to the first embodiment of the present invention. A method for controlling the setup time tCLS will be described with reference to FIGS. 3 and 4.

If a semiconductor memory device having the control signal generation circuit 300 operates normally (hereafter, this is referred to as a normal mode), the selection circuit 335 outputs a signal inputted to its first input terminal A, i.e., a signal corresponding to an output signal of the first latch 310, as the column latch signal COLLAT in response to a test enable signal TEST_EN at a first state, e.g., logic low.

Thus, in the normal mode, the data input/output command signal COLCYC is activated after 2tCK from when the column latch signal COLLAT is activated. That is, the data input/output command signal COLCYC is activated by the second and third latches 325 and 345 which operate in response to the clock signal CLK after 2tCK from when the column latch signal COLLAT is activated.

However, when the semiconductor memory device having the control signal generation circuit 300 is tested (hereinafter, this is referred to as a test mode), the selection circuit 335 outputs a signal inputted to its second input terminal B, that is, the output signal INF2 of the second latch 325, as the column latch signal COLLAT in response to a test enable signal TEST_EN at a second state, e.g., logic high.

Thus, in the test mode, the data input/output command signal COLCYC is activated after 1tCK from when the column latch signal COLLAT is activated. That is, the data input/output command signal COLCYC is activated by the third latch 345, which operates in response to the clock signal CLK, after 1tCK from when the column latch signal COLLAT is activated.

The setup time tCLS_T during which the column latch signal COLLAT is activated in the test mode is 1tCK, i.e., 2-bit time slower than the setup time tCLS_N during which the column latch signal COLLAT is activated in the normal mode.

Therefore, the control signal generation circuit 300 reduces the setup time tCLS from 2tCK to 1tCK. In addition, the present invention can be applied so as to control the setup time tCLS of the clock signal CLK in units of bit time.

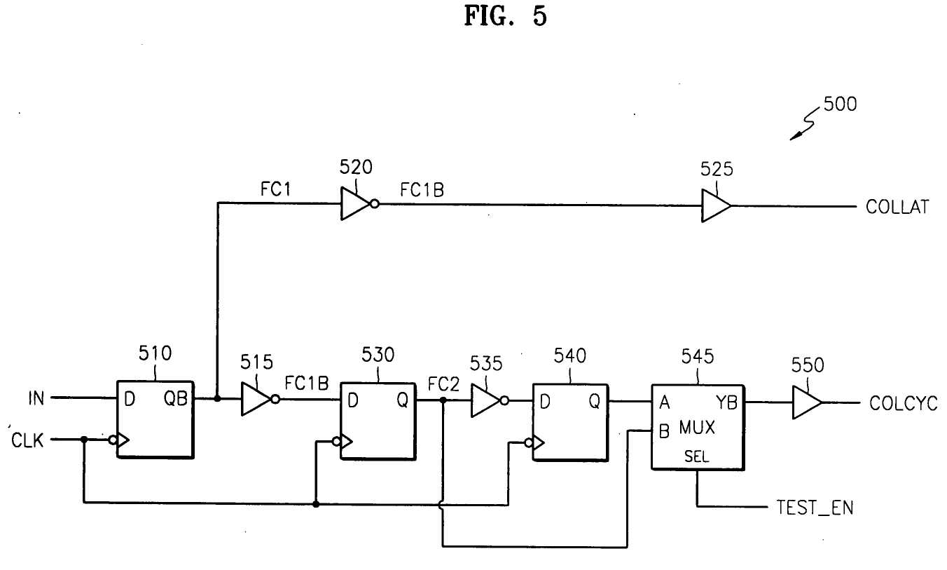

FIG. 5 is a circuit diagram of a control signal generation circuit 500 according to a second embodiment of the present invention. The control signal generation circuit 500 of FIG. 5 is used to control when the data input/output command signal COLCYC is activated.

The control signal generation circuit 500 includes a first latch 510, a second latch 530, a third latch 540, and a selection circuit 545.

The first latch 510 latches an input signal IN in response to a clock signal CLK. The second latch 530 latches an output signal FC1 of the first latch 510 in response to the clock signal CLK. The third latch 540 latches an output signal FC2 of the second latch 530 in response to the clock signal CLK.

The input signal IN is generated by decoding the data write/read command signal CMD inputted to the interface 10 of FIG. 1.

The selection circuit 545 selectively outputs the output signal FC2 of the second latch 530 or an output signal of the third latch 540 corresponding to the state (logic low or high) of a test enable signal TEST_EN. That is, the setup time tCLS is controlled in units of bit time of the clock signal CLK.

The control signal generation circuit 500 further includes a first inverter 520, a second inverter 515, a third inverter 535, and two buffers 525 and 550 considering a relationship among phases of the input signal IN, the column latch signal COLLAT, and the data input/output command signal COLCYC.

Hereafter, the control signal generation circuit 500 is described to facilitate understanding of its operation of controlling the setup time tCLS in units of bit time.

The first latch 510 transmits the input signal IN inputted to its input terminal D to the first inverter 520 and the second inverter 515 through its output terminal QB in response to a falling edge of the clock signal CLK.

The first inverter 520 is connected between the output terminal QB of the first latch 510 and an input terminal of the buffer 525, inverts the output signal FC1 of the first latch 510 into an inverted output signal FC1B, and outputs the inverted output signal FC1B to the input terminal of the buffer 525.

The buffer 525 buffers the inverted output signal FC1B of the first inverter 520 and outputs the buffered result as the column latch signal COLLAT.

The second inverter 515 is connected between the output terminal QB of the first latch 510 and an input terminal D of the second latch 530, inverts the output signal FC1 of the first latch 510 into the inverted output signal FC1B, and outputs the inverted output signal FC1B to the input terminal D of the second latch 530.

The second latch 530 transmits the inverted output signal FC1B of the first inverter 515 as an output signal FC2 to the third inverter 535 and a second input terminal B of the selection circuit 545. The third inverter 535 is connected between the output terminal Q of the second latch 530 and an input terminal D of the third latch 540.

The third latch 540 transmits an output signal of the third inverter 535 to a first input terminal A of the selection circuit 545 in response to the clock signal CLK.

The selection circuit 545 selectively outputs the output signal FC2 of the second latch 530 or the output signal of the third latch 540 to the buffer 550 corresponding to the state (logic low or high) of the test enable signal TEST_EN.

The buffer 550 buffers an output signal of the selection circuit 545 and outputs the buffered result as the data input/output command signal COLCYC. The selection circuit 545 may be a two-input/one-output multiplexer.

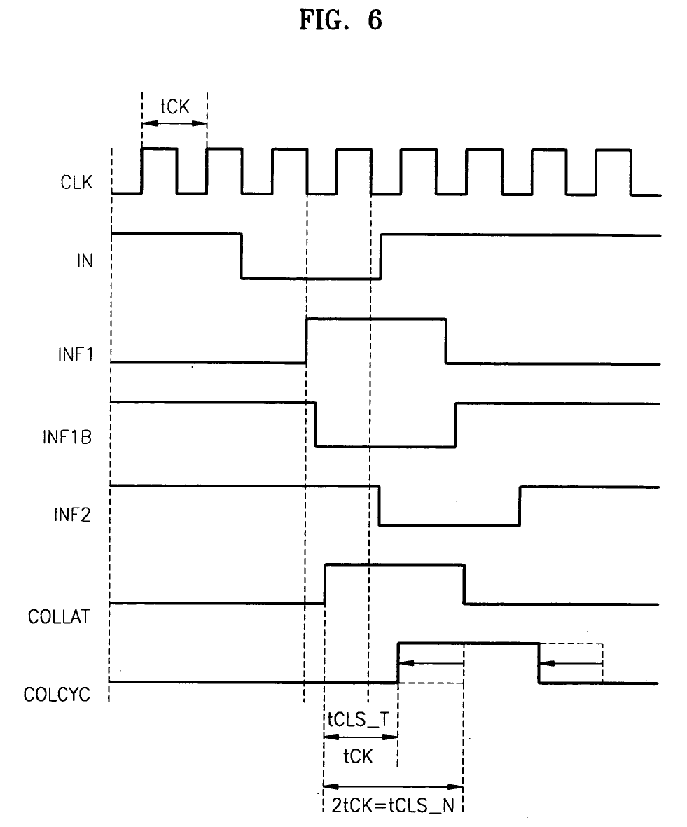

FIG. 6 is a timing diagram for the control signal generation circuit 500 according to the second embodiment of the present invention. Hereinafter, a method of controlling the setup time tCLS will be described with reference to FIGS. 5 and 6.

In a normal mode, the first latch 510 outputs the output signal FC1, which is an inverted signal of the input signal IN, to the first inverter 520 in response to the falling edge of the clock signal CLK. The first inverter 520 inverts the output signal FC1 of the first latch 510 into the inverted output signal FC1B. The inverted output signal FC1B is outputted as the column latch signal COLLAT by the buffer 525.

The selection circuit 545 outputs a signal inputted to its first input terminal A in response to a test enable signal TEST_EN at a first state, e.g., logic low, after 2tCK from when the column latch signal COLLAT is activated.

Thus, in the normal mode, the data input/output command signal COLCYC is activated after 2tCK from when the column latch signal COLLAT is activated. That is, the data input/output command signal COLCYC is activated by the second and third latches 530 and 540, which operate in response to the clock signal CLK, after 2tCK from when the column latch signal COLLAT is activated.

However, in a test mode, the selection circuit 545 outputs a signal inputted to its second input terminal B, that is, the inverted output signal FC1B of the second latch 530, in response to a test enable signal TEST_EN at a second state, e.g., logic high.

Thus, in the test mode, the data input/output command signal COLCYC is activated after 1tCK from when the column latch signal COLLAT is activated.

The setup time tCLS_T during which the column latch signal COLLAT is activated in the test mode is 1tCK, i.e., 2 bit times slower than the setup time tCLS_N during which the column latch signal COLLAT is activated in the normal mode.

Therefore, the control signal generation circuit 500 reduces the setup time tCLS from 2tCK to 1tCK. In addition, the present invention can be applied so as to control the setup time tCLS of the clock signal CLK in units of bit time.

According to the control signal generation circuit and the method for generating control signals of the present invention, it is possible to effectively test a semiconductor memory device having the control signal generation circuit, irrespective of the operating frequency of test equipment, by controlling the setup time tCLS in units of bit time of a clock signal.

While the present invention has been particularly shown and described with reference to exemplary embodiments thereof, it will be understood by those of ordinary skill in the art that various changes in form and details may be made therein without departing from the spirit and scope of thereof as defined by the appended claims.

What is claimed is:

1. A control signal generation circuit comprising:
an input terminal;
a first output terminal; and
a second output terminal,
wherein the control signal generation circuit receives, in response to a clock signal, an input signal inputted to the input terminal and outputs a column latch signal and a data input/output command signal, which are separately activated and have a first time interval therebetween, to the first output terminal and the second output terminal, respectively, each in response to a test enable signal at a first state, or outputs the column latch signal and the data input/output command signal, which are separately activated and have a second time interval therebetween, to the first output terminal and the second output terminal, respectively, each in response to a test enable signal at a second state,
wherein the first time interval and the second time interval are controlled in units of bit time of the clock signal, and the second time interval is controlled to be smaller than the first time interval.

2. The control signal generation circuit of claim 1, wherein the first time interval and the second time interval each amount to a time from when the column latch signal is activated to when the data input/output command signal is activated.

2. A control signal generation circuit comprising:
a first latch which latches an input signal in response to a clock signal;
a second latch which latches an output signal of the first latch in response to the clock signal;
a selection circuit which outputs the output signal of the first latch or an output signal of the second latch as a column latch signal in response to a test enable signal; and
a third latch which latches the output signal of the second latch as a data input/output command signal in response to the clock signal,
wherein the amount of time from when the column latch signal is activated to when the data input/output command signal is activated is controlled in units of bit time of the clock signal.

4. The control signal generation circuit of claim 3, wherein the input signal is generated by decoding a data write/read command signal and is activated in response to the data write/read command signal.

5. The control signal generation circuit of claim 3 further comprising:
a first inverter which is connected between an output terminal of the first latch and a first input terminal of the selection circuit;
a second inverter which is connected between the output terminal of the first latch and an input terminal of the second latch; and
a third inverter which is connected between the output terminal of the second latch and an input terminal of the third latch,
wherein the output terminal of the second latch is connected to a second input terminal of the selection circuit.

6. The control signal generation circuit of claim 3, wherein the output signal of the first latch is an inverted signal of the input signal.

7. A control signal generation circuit comprising:
a first latch which latches an input signal in response to a clock signal;
a second latch which latches an output signal of the first latch in response to the clock signal;
a third latch which latches an output signal of the second latch in response to the clock signal; and
a selection circuit which outputs one of the output signal of the second latch and an output signal of the third latch in response to a test enable signal,
wherein the amount of time from when the output signal of the first latch is activated to when an output signal of the selection circuit is activated is controlled in units of bit time of the clock signal.

8. The control signal generation circuit of claim 7 comprising:
a first inverter which inverts the output signal of the first latch;
a second inverter which is connected between an output terminal of the first latch and an input terminal of the second latch; and
a third inverter which is connected between an output terminal of the second latch and an input terminal of the third latch,
wherein the selection circuit has a first input terminal connected to an output terminal of the third latch and a second input terminal connected to the output terminal of the second latch.

9. The control signal generation circuit of claim 7, wherein the output signal of the first latch is a column latch signal, and the output signal of the selection circuit is a data input/output command signal.

10. The control signal generation circuit of claim 7, wherein the output signal of the first latch is an inverted signal of the input signal.

11. A method for generating a control signal, the method comprising:
receiving a data write/read command signal inputted to an input terminal of a control signal generation circuit, in response to a clock signal; and
outputting a column latch signal and a data input/output command signal, which are separately activated and have a first time interval therebetween, to the first input terminal and the second input terminal, respectively, each in response to a test enable signal at a first state, or outputting the column latch signal and the data input/output command signal, which are separately activated and have a second time interval therebetween, to the first output terminal and the second output terminal, respectively, each in response to a test enable signal of a second state,
wherein the first time interval and the second time interval are controlled in units of bit time of the clock signal, and the second time interval is controlled to be smaller than the first time interval.

12. The method of claim 11, wherein the first time interval and the second time interval each amount to a time from when the column latch signal is activated to when the data input/output command signal is activated.
